(19) United States
(12) Patent Application Publication
(10) Pub. No.: US 2026/0035758 A1
(43) Pub. Date: Feb. 5, 2026

(54) USE OF TAIL GAS MADE OF THE DISCHARGED GAS OF A REDUCTION PROCESS OF IRON OXIDE-CONTAINING MATERIAL

(71) Applicant: PRIMETALS TECHNOLOGIES AUSTRIA GMBH, Linz (AT)

(72) Inventors: Robert MILLNER, Loosdorf (AT); Norbert REIN, Wien (AT); Johann WURM, Bad Zell (AT); Karl-Heinz ZELLINGER, Linz (AT)

(73) Assignee: PRIMETALS TECHNOLOGIES AUSTRIA GMBH, Linz (AT)

(21) Appl. No.: 19/139,437

(22) PCT Filed: Dec. 13, 2023
(86) PCT No.: PCT/EP2023/085656

§ 371 Date: Jun. 16, 2025

(30) Foreign Application Priority Data
Dec. 20, 2022 (EP) 22214825.6
Apr. 27, 2023 (EP) 23170274.7

(51) Int. Cl. C21B 13/00

(52) U.S. Cl. CPC C21B 13/0073; C21B 2100/40; C21B 2100/66

(57) ABSTRACT

A method for producing molten iron. The reduction of iron oxide-containing material to form a metallized product is performed using a reduction gas consisting at least largely of hydrogen H2. Top gas is accumulated during the reduction process. First sub-quantity of top gas is combined with reducing reduction gas components to provide reduction gas, and second sub-quantity of the top gas, as a discharged gas, is subjected to a gas separation process into a hydrogen-enriched gas flow and a hydrogen-depleted tail gas flow. Metallized product of the reduction process is combined with carbon carriers to be melted in a melting device to form a molten iron, and a smelting exhaust gas is accumulated. Sub-quantity of the tail gas flow is combined with at least a sub-quantity of the smelting exhaust gas, and a tail gas mixture is produced. Sub-quantity of the tail gas mixture is supplied to a thermal use.

### CROSS-REFERENCE TO RELATED APPLICATIONS

The present application is a national phase application of PCT Application No. PCT/EP2023/085656, filed Dec. 13, 2023, entitled “USE OF TAIL GAS MADE OF THE DISCHARGED GAS OF A REDUCTION PROCESS OF IRON OXIDE-CONTAINING MATERIAL”, which claims the benefit of European Patent Application No. 22214825.6 filed Dec. 20, 2022, and European Patent Application No. 23170274.7 filed Apr. 27, 2023, each of which is incorporated by reference in its entirety.

### BACKGROUND OF THE INVENTION

### 1. Field of the Invention

The application relates to processes for producing an iron melt, wherein reduction of iron oxide-containing material to afford a metallized product is carried out using a reduction gas composed at least predominantly of hydrogen H2, wherein the reduction generates top gas.

### 2. Description of the Related Art

The reduction of metal oxide-containing, for example iron oxide-containing, material—for example ores, oxide briquettes or pellets—using reducing gases is known. For instance reduction by direct reduction in a fixed bed or a fluidized bed with reduction gas. In conventional pre-reduction and direct reduction processes currently employed on a large industrial scale the reduction gas is based not only on hydrogen but also predominantly on carbon—for example in carbon monoxide CO and/or methane CH4—from natural gas. This therefore generates large amounts of carbon dioxide CO2 which is undesirable inter alia for environmental policy reasons.

A known means of reducing CO2 emissions in the direct reduction of metal oxide-containing material is to use hydrogen H2 as reducing gas. It is possible here to use hydrogen as the sole reduction gas, or in combination with other gases that are based, for example, on carbon from natural gas or on coal or coke. The greater the proportion of CO2-neutral hydrogen H2 in the reduction gas, the lower the emission of CO2. Depending on the availability of natural gas or other gases and of hydrogen, the ratio of their contribution to the reduction gas can be varied by mixing different amounts.

The more hydrogen is available, the greater the extent to which a climatically problematic contribution based on carbon from natural gas or other gases can be avoided.

It is favorable to operate existing plants and procedures in which the reduction gas is based predominantly on carbon and partly hydrogen from natural gas or other gases, including with elevated proportions of hydrogen in the reduction gas. This enables flexible reaction to the availability of natural gas or other gases and of hydrogen, and permits exploitation of investments that have already been made in plant. At least until sufficient volumes of hydrogen for the use of reduction gases based entirely on hydrogen are available, reduction gas will still have to make use of reducing components from natural gas or other gases in addition to hydrogen.

In order to preserve resources it is customary in direct reduction processes to utilize used reduction gas—known as top gas—to prepare reduction gas. To this end the top gas, optionally after treatment steps such as for example dedusting or compression, is mixed with fresh reduction gas components—for example gas from a reformer for reforming natural gas, hydrogen H2 from a hydrogen production plant, ammonia NH3. Reducing components remaining in the top gas may thus be sent to the direct reduction and used as reducing agents once again. The disadvantage of such a recirculation of the top gas is that the top gas also contains non-reducing components—for example nitrogen N2 or carbon dioxide CO2. Recirculation allows these components to accumulate ever more in the reduction gas. In order to limit enrichment a sub-amount of the top gas is discharged from the circuit as so-called discharge gas—also known as bleed gas.

To help conserve resources, utilization of the discharge gas is desirable. This is especially the case when using hydrogen-rich reduction gas since the hydrogen content of the top gas increases with increasing hydrogen content in the reduction gas.

Thermal utilization of discharge gas through combustion thereof for example with an oxidant—for example air—and the utilization of the heat for heating a medium is known; the medium may be a reduction gas precursor for example.

Separation of the hydrogen H2 from other components of the discharge gas and utilization thereof for preparation of reduction gas is likewise known. The sub-amount of the discharge gas remaining after separation of hydrogen H2—also known as tail gas—is unsuitable for thermal utilization on its own due to its low calorific value and is flared off unutilized after addition of fuel.

### SUMMARY OF THE INVENTION

The problem addressed by the present invention is that of providing processes and apparatuses which allow the utilization of tail gas when using reduction gas composed predominantly of hydrogen H2.

The problem is solved by a
process for producing an iron melt, wherein
reduction of iron oxide-containing material to afford a metallized product is carried out using a reduction gas composed at least predominantly of hydrogen H2, wherein the reduction generates top gas
and wherein—optionally after a treatment of the top gas—a first sub-amount of the top gas is combined with reducing reduction gas components to prepare reduction gas and a second sub-amount of the top gas as discharge gas is subjected to a gas separation into a hydrogen-enriched gas stream and into a hydrogen-depleted tail gas stream
and wherein the metallized product of the reduction combined with carbon carriers is melted in a melting apparatus to afford an iron melt, wherein a melting offgas is generated, characterized in that
at least a sub-amount of the tail gas stream is combined with at least a sub-amount of the melting offgas to form a tail gas mixture and at least a sub-amount of the tail gas mixture is sent to a thermal utilization.

The reduction gas is at least predominantly composed of hydrogen H2. This is to be understood as meaning that the reduction gas contains hydrogen as the reducing reduction gas component, wherein the content of hydrogen in % by volume is greater than that of any of the other optionally present reduction gas components; the content of hydrogen is preferably at least 50% by volume, particularly preferably more than 50% by volume, very particularly preferably at least 60% by volume.

Other optionally present reduction gas components which may also have a reducing effect include for example carbon monoxide CO or hydrocarbons or ammonia NH3.

The metallized product is preferably direct reduced iron, DRI, which is also known as sponge iron.

The optionally performed treatment of the top gas may include for example treatment types such as dedusting—which may be carried out wet or dry—compression, heat exchange, cooling. The treatment may be single-stage or multi-stage and one or more treatment types may be employed.

The first and the second sub-amount of the top gas may have the same composition or may differ in their composition.

It is preferable when the first and the second sub-amount of the top gas have the same composition, i.e. the volume stream is merely divided into two sub-streams.

The metallized product of the reduction combined with carbon carriers is melted in a melting apparatus to afford an iron melt. Combining with carbon carriers may be carried out before introduction into the melting apparatus or in the melting apparatus.

The melting apparatus is for example a member of the group consisting of
electric arc furnace (EAF),
submerged arc furnace (SAF),
open slag bath furnace (OSBF),
melting unit,
converter vessel.

A melting unit effects melting at least partially on the basis of electrical energy.

EAF, SAF, and OSBF are not to be understood as melting units in the context of this application.

A converter vessel is to be understood as meaning for example a steelmaking converter for steel production.

Thermal utilization is an exothermic reaction with a reaction partner, for example combustion with oxygen or other oxidizing reaction partners.

The thermal utilization is preferably carried out in the environment of the process for producing iron melt, for example thermal utilization for heating process gas streams or for producing steam to generate electricity required in the process.

### Advantageous Effects of the Invention

Due to the presence of carbon carriers during melting the melting offgas contains for example carbon monoxide CO and thus has a higher calorific value than tail gas. The tail gas mixture obtained according to the invention therefore has an elevated calorific value compared to tail gas and is suitable for a thermal utilization. Combining the two gases generated during the process according to the invention for producing iron melt thus allows for a utilization of tail gas.

It is preferable when the thermal utilization comprises a supply of heat to a member of the group comprising
reformer
reduction gas heater
drying apparatus for iron oxide-containing material
heating apparatus for iron oxide-containing material
treatment apparatus for iron oxide-containing material
steam or hot water generation apparatus.

A contribution to providing the heat necessary for the reforming may be provided in a reformer for example.

A contribution to reaching the temperature desired for the reduction gas may be provided in a reduction gas heater for example.

A contribution to providing heat promoting drying may be provided in a drying apparatus for iron oxide-containing material.

A contribution to providing heat necessary for heating may be provided in a heating apparatus for iron oxide-containing material—it is possible for example to effect heating to promote pre-oxidation of material.

A contribution to providing heat necessary for treatment may be provided in a treatment apparatus for iron oxide-containing material, for example a sintering plant or a pelletizing plant.

A contribution to providing heat necessary for steam or hot water production may be provided in a steam or hot water generation apparatus—the steam or hot water may then be utilized directly or for generating electricity for example.

The thermal utilization of the tail gas mixture generates a first offgas.

It is preferable when at least a sub-amount of the tail gas mixture is used in an inert gas generator.

In an inert gas generator combustion of the tail gas mixture with air produces inert gas—for example the combustion produces the inert gas carbon dioxide CO2 which barely reacts under the usage conditions.

The inert gas may be utilized for example in the reduction unit in which the iron oxide-containing material is reduced to afford a metallized product or in the melting apparatus, for example for purging purposes.

Following the above-described formation of a tail gas mixture it would in principle also be possible to utilize the entire tail gas mixture in an inert gas generator so that no sub-amount of the inert gas mixture is sent to a thermal utilization.

It is preferable when at least a sub-amount of the melting offgas is utilized in a reformer.

The reformer can supply reducing components for the reduction gas.

Utilization may for example be effected according to

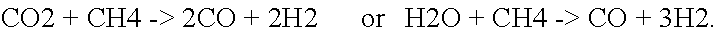

Carbon dioxide CO2 or steam H2O in the melting offgas are for example reacted with natural gas in the reformer, so that the reducing components carbon monoxide CO and hydrogen H2 are produced and serve as reducing components of the reduction gas.

Melting offgas from a melting apparatus in which metallized product of a reduction combined with carbon carriers is melted to afford an iron melt may in principle also be entirely utilized in a reformer to provide reducing components for the reduction gas performing the reduction.

However, in this case no sub-amount of the melting offgas would be available for combining with tail gas upon connecting a melting apparatus in which metallized product of a reduction combined with carbon carriers is melted to afford an iron melt with the above-described formation of a tail gas mixture.

The iron oxide-containing material is reduced to the metallized product in a reduction unit. The reduction unit in which the iron oxide-containing material is reduced to a metallized product may be for example a fixed bed shaft or a moving bed reactor or a fluidized bed reactor. Process-intrinsic vent gas is generated when the metallized product—for example direct-reduced iron DRI—is pneumatically conveyed from the reduction unit into a DRI bunker where solid and gas are separated to generate vent gas. The vent gas may be utilized as fuel optionally after—wet or dry—dedusting.

In one embodiment the discharge gas is admixed with at least a sub-amount of the process-intrinsic vent gas before the gas separation into a hydrogen-enriched gas stream and into a hydrogen-depleted tail gas stream is carried out. In this case a mixture of discharge gas and process-intrinsic vent gas is subjected to a gas separation into a hydrogen-enriched gas stream and into a hydrogen-depleted tail gas stream.

It is preferable when the thermal utilization is carried out with supply of at least one fuel to the tail gas mixture, for example natural gas or process-intrinsic vent gas.

This makes it possible to increase the calorific value of the tail gas mixture.

The tail gas mixture is preferably sent to a gas storage means before thermal utilization and withdrawn from the gas storage means for the thermal utilization. This makes it possible to compensate variations over time in the compositions and/or generated amounts of the tail gas stream and/or of the melting gas stream and/or of the fuel—for example process-intrinsic vent gas and/or natural gas.

Both the tail gas stream and the stream of the melting offgas but also streams of the fuel—for example process-intrinsic vent gas and/or natural gas—may vary over time in terms of composition and amount.

It is preferable when at least one fuel is also introduced into the gas storage means. A mixture of fuel and tail gas mixture may then be sent to the thermal utilization. Variations in the calorific value of the tail gas stream and/or of the melting gas stream and/or of the fuel—for example process-intrinsic vent gas or natural gas—and therefore of the tail gas mixture may thus be compensated in the gas storage means. Introduction into the gas storage means is preferably controlled such that the calorific value of the mixture of tail gas mixture and fuel withdrawn from the gas storage means corresponds to the value desired for the thermal utilization.

### BRIEF DESCRIPTION OF THE DRAWINGS

The present invention will now be described by way of example with reference to a schematic FIGURE.

The above-described properties, features, and advantages of this invention and the manner in which they are achieved will become clearer and more clearly comprehensible in conjunction with the following description of embodiments, which are elucidated more particularly in conjunction with the schematic and exemplary drawing. In the FIGURES:

FIG. 1 is a schematic diagram of one embodiment of the process according to the invention.

### DETAILED DESCRIPTION

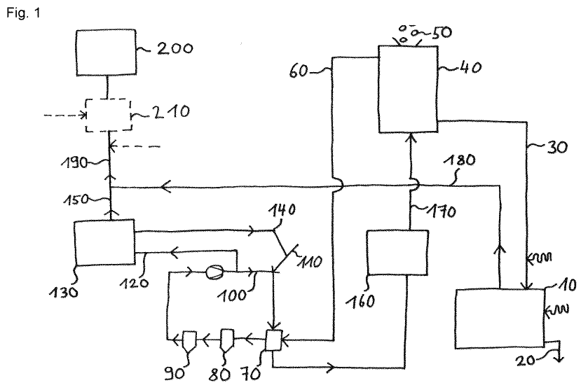

FIG. 1 is a schematic diagram of how an iron melt 20 is produced in a melting apparatus 10. To this end the metallized product 30—for example DRI—is obtained from iron oxide-containing material 50 by reduction in a reduction unit 40 using a reduction gas composed predominantly of hydrogen. Top gas 60 generated in the reduction is discharged from the reduction unit 40 and after a multistage treatment comprising heat exchange 70, dry dedusting 80 and cooling 90 with water is divided into two sub-amounts. A first sub-amount 100 is combined with reducing reduction gas components 110 and a second sub-amount 120 is sent to a gas separation apparatus 130 in which a hydrogen-enriched gas stream 140 and a hydrogen-depleted tail gas stream 150 are generated. As shown, the hydrogen-enriched gas stream 140 is passed to the feed of the reducing reduction gas components 110—it may be one of a plurality of reducing reduction gas components or the only one.

Combining with reducing reduction gas components is followed by heating of the resulting reduction gas precursor by heat exchange 70 and electrical heating 160 and the thus-produced reduction gas 170 is supplied to the reduction unit 40.

The metallized product 30 is sent to the melting apparatus 10 and, combined with carbon carriers, is melted in the melting apparatus 10 to afford an iron melt 20. Addition of carbon carriers is indicated with wavy arrows; the FIGURE shows the two variants combining with carbon carriers before introduction into the melting apparatus 10 and combining with carbon carriers in the melting apparatus 10; each of the variants may be present alone or both variants may be present in combination.

Melting offgas 180 generated in the melting apparatus 10 is combined with the tail gas stream 150 to form a tail gas mixture 190. Tail gas mixture 190 is sent to a thermal utilization 200. It is optionally sent to a gas storage means 210 before thermal utilization 200.

The tail gas mixture 190 and/or the gas storage means 210 are optionally—represented by dashed arrows—admixed with fuel.

### LIST OF REFERENCE NUMERALS

10 Melting apparatus
20 Iron melt
30 Metallized product
40 Reduction unit
50 Iron oxide-containing material
60 Top gas
70 Heat exchange
80 Dry dedusting
90 Cooling
100 First sub-amount
110 Reducing reduction gas components
120 Second sub-amount
130 Gas separation apparatus
140 Hydrogen-enriched gas stream
150 Tail gas stream
160 Electrical heating
170 Reduction gas
180 Melting offgas
190 Tail gas mixture
200 Thermal utilization
210 Gas storage means

1-8. (canceled)

9. A method for producing an iron melt, comprising:
reducing iron oxide-containing material to obtain a metallized product using a reduction gas composed at least predominantly of hydrogen H2;
generating top gas by the reducing operation;
combining a first sub-amount of the top gas with reducing reduction gas components to prepare reduction gas;
separating, using a gas separation apparatus, a second sub-amount of the top gas as discharge gas into a hydrogen-enriched gas stream and into a hydrogen-depleted tail gas stream;
melting, in a melting apparatus, the metallized product of the reduction combined with carbon carriers to obtain an iron melt, a melting offgas being generated;
combining at least a sub-amount of the tail gas stream with at least a sub-amount of the melting offgas to form a tail gas mixture; and
sending at least a sub-amount of the tail gas mixture to a thermal utilization.

10. The method as claimed in claim 9, wherein the combining of the first sub-amount of the top gas is with the reducing reduction gas components is performed after a treatment of the top gas.

11. The method as claimed in claim 9, wherein the thermal utilization comprises supplying heat to a member of a group comprising:
a reformer;
a reduction gas heater;
a drying apparatus for iron oxide-containing material;
a heating apparatus for iron oxide-containing material;
a treatment apparatus for iron oxide-containing material; and
a steam or hot water generation apparatus.

12. The method as claimed in claim 9, wherein at least a sub-amount of the tail gas mixture is utilized in an inert gas generator.

13. The method as claimed in claim 9, wherein at least a sub-amount of the melting offgas is utilized in a reformer.

14. The method as claimed in claim 9, wherein the discharge gas is admixed with at least a sub-amount of the process-intrinsic vent gas before separating the second sub-amount of the top gas into the hydrogen-enriched gas stream and into the hydrogen-depleted tail gas stream.

15. The method as claimed in claim 9, wherein the thermal utilization is performed with supply of at least one fuel to the tail gas mixture.

16. The method as claimed in claim 9, wherein the tail gas mixture is sent to a gas storage before the thermal utilization and withdrawn from the gas storage for the thermal utilization.

17. The method as claimed in claim 16, wherein at least one fuel is also introduced into the gas storage.
